(19) United States
(12) Patent Application Publication
(10) Pub. No.: US 2004/0240772 A1
(43) Pub. Date: Dec. 2, 2004

(54) Integrated optical structure

(76) Inventors: Gregory Pandraud, Grenoble (FR); Julien Gamet, Grenoble (FR)

Correspondence Address: YOUNG & THOMPSON, 745 SOUTH 23RD STREET, 2ND FLOOR, ARLINGTON, VA, 22202, US

(21) Appl. No.: 10/484,084

(22) PCT Filed: Jul. 4, 2002
(86) PCT No.: PCT/FR02/02331

(30) Foreign Application Priority Data
Jul. 16, 2001 (FR) 01/09485

(51) Int. Cl. G02B 6/12

(52) U.S. Cl. 385/14; 385/37

(57) ABSTRACT

An integrated optical structure includes at least one layer containing an optical coupling element which defines a free light propagation region, at least one input optical waveguide and a network of optical waveguides, which are disposed in relation to one another such that the optical wave exiting the output end of the input optical waveguide reaches the input ends of the optical waveguides forming the network, via the optical coupling element. In an area located at a distance from, and frontally to, the aforementioned output end of the input optical waveguide, the optical coupling element comprises optical transfer or transformation elements which are used to diminish the amplitude and/or modify the phase and/or partially stop the propagation of the optical wave coming from the output of the input optical waveguide before it reaches the inputs of the optical waveguides of the network.

The present invention relates to an integrated optical structure, in particular for multiplexing/demultiplexing an optical wave, and to a process for fabricating it.

Integrated multiplexing/demultiplexing optical structures generally comprise, in a layer of the structure and in the following order, an input optical microguide, an input optical coupling element, a network of intermediate optical microguides having different lengths so as to constitute a dispersive element, an output optical coupling element and output microguides.

In simple terms such a structure operates as follows.

An optical wave arriving via the input optical micro-guide and transporting or containing optical-signal channels of different wavelengths diffracts, in free space, or by free propagation in the input optical coupling element, and illuminates the inputs of the intermediate optical microguides of the network.

Each intermediate optical microguide of the network takes a sample from the optical wave emanating from the input optical microguide. When these samples reach the outputs of the intermediate optical microguides of the network, there is a wavelength-dependent phase difference between them.

Next, the optical-wave samples leaving the intermediate optical microguides of the network diffract in the output optical coupling element and illuminate the inputs of the output optical microguides.

The aforementioned optical structure is designed so as to produce a transfer function by a double Fourier transform such that the optical waves taken off by the output optical microguides transport or contain the respective optical-signal channels transported or contained in the input optical wave.

Such structures have been described in particular in documents EP-A-301 194, EP-A-936 482 and WO-A-133270.

More particularly, document EP-A-936 482 describes an integrated optical structure in which there are provided, one after the other, two networks of optical microguides connected via an intermediate optical coupling element with free propagation. This arrangement makes it possible to obtain filtering such that, in each of the output optical microguides, the Gaussian curve representing the intensity of the optical waves is flattened at its top.

Moreover, it is proposed in document EP-A-936 482 to produce, in the aforementioned intermediate optical coupling element joining the aforementioned two networks, elongate slots that extend so as to form a V, the opening of which is turned toward the outputs of the optical microguides of the first network in such a way that the faces that face these slots constitute mirrors or deflectors for limiting optical losses, without modification of the characteristics of the optical wave scattered in this intermediate optical coupling element.

It is an object of the present invention to improve the integrated optical devices, in particular for the purpose of achieving optical wave multiplexing/demultiplexing of higher performance.

The subject of the present invention is firstly an integrated optical structure comprising at least one layer in which an optical coupling element defining a free propagation region for the light, at least one input optical waveguide and optical waveguides constituting a network are defined, these being arranged one with respect to another in such a way that the optical wave leaving via the output end of said input optical waveguide reaches the input ends of the optical waveguides constituting said network through said optical coupling element.

According to the invention, said optical coupling element preferably includes, in a place located at a certain distance from and transversely across the aforementioned output end of said input optical waveguide, optical transfer or transformation means for attenuating the amplitude and/or modifying the phase and/or partly stopping the propagation of the optical wave emanating from the output of the input optical waveguide before said wave reaches the aforementioned inputs of the optical waveguides of said network.

The subject of the present invention is also an integrated wavelength-multiplexing/demultiplexing structure of optical-signal channels arranged in such a way that the distance separating their successive nominal wavelengths is preferably equal to a set value and/or to a multiple of this set value. This optical structure preferably comprises, in at least one layer, at least one input optical waveguide, output optical waveguides, a network of intermediate waveguides having different lengths, an input optical coupling element defining a free propagation region that extends between the output end of the input optical waveguide and the input ends of the optical waveguides of said network in such a way that the optical wave emanating from the input optical waveguide reaches the inputs of the intermediate optical waveguides of said network through said optical coupling element, and an output optical coupling element defining a free propagation region that extends between the output ends of the intermediate optical waveguides of said network and the input ends of the output waveguides in such a way that the optical waves emanating from the outputs of the intermediate optical waveguides of said network reach the inputs of the output optical waveguides through said optical coupling element.

According to the invention, said input optical coupling element preferably includes, in a place located at a certain distance from and transversely across the aforementioned output end of said input optical waveguide, transfer or transformation means for attenuating the amplitude and/or modifying the phase and/or partly stopping the propagation of the optical wave emanating from the input optical waveguide before said wave reaches the aforementioned inputs of the optical waveguides of said network.

Thus, the intensity of the optical waves reaching the respective inputs of the output optical waveguides is, when plotted as a function of the deviation from the corresponding nominal wavelength, in the form of a bell with a flattened top or of a rectangle.

According to the invention, said transfer or trans-formation means preferably comprise obstacles that at least partly prevent propagation of the light emanating from the output of the input optical guide and define, between said obstacles, a space for passage of the light, preferably placed transversely, from the output of the input waveguide.

According to the invention, said obstacles preferably comprise cavitied parts or spaced-apart slots.

According to the invention, the opening of the angle whose vertex is preferably located on the output of said input waveguide, and the sides of this angle are preferably tangents to said space separating said parts of said transfer or transformation means, is between 0.5 and 25 degrees.

According to the invention, said transfer or transformation means are preferably placed on the image surface comprising the inputs of the output optical waveguides, through the optical system consisting of that part of the input optical coupling element that extends between said transfer or transformation means and the inputs of the optical waveguides constituting said network and the output optical coupling element.

The subject of the present invention is also an integrated optical structure comprising at least one layer in which an optical coupling element defining a free propagation region for the light, at least one input optical waveguide and optical waveguides constituting a network are defined, these being placed one with respect to another in such a way that the optical wave leaving via the end of said input optical waveguide reaches the input ends of the optical waveguides constituting said network through said optical coupling element.

According to the invention, said optical coupling element comprises, in a place located at a certain distance from and transversely across the aforementioned output end of said input optical waveguide, obstacles at least partly preventing propagation of the light emanating from the output of the input optical waveguide before said light reaches the aforementioned inputs of the optical waveguides of said network and defining, between them, a space for passage of the light to the aforementioned inputs of the optical waveguides of said network.

According to the invention, said obstacles preferably consist of elongate slots formed approximately in a plane perpendicular to the main direction of the output of the light from the input waveguides.

According to the invention, the slots extend over at least the thickness of the waveguides.

According to the invention, said obstacles are preferably placed on the image surface comprising the inputs of the output optical waveguides, through the optical system consisting of that part of the optical coupling element that extends between said transfer or transformation means and the inputs of the optical waveguides constituting said network and the output optical coupling element.

The subject of the present invention is also a process for producing the aforementioned optical structure, which preferably consists in embedding the transmission cores of said optical waveguides in a layer, and in producing said obstacles in the thickness of this layer.

The present invention will be more clearly understood by studying an integrated optical structure described by way of non-limiting example and illustrated by the drawing, in which:

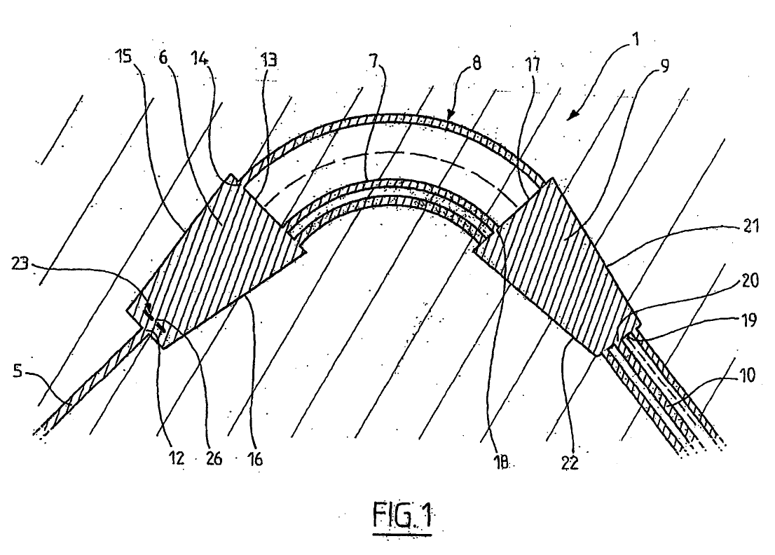

FIG. 1 shows a horizontal cross section of an integrated optical structure according to the present invention;

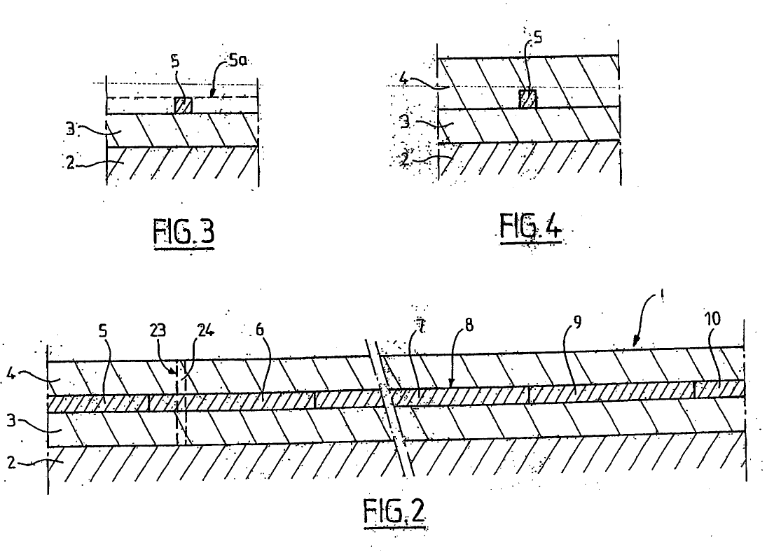

FIG. 2 shows a vertical cross section of the optical structure of FIG. 1, along an optical path;

FIG. 3 shows a cross section on III-III of the optical structure of FIG. 1, in the course of fabrication;

FIG. 4 shows the cross section on III-III of the optical structure of FIG. 1, after fabrication;

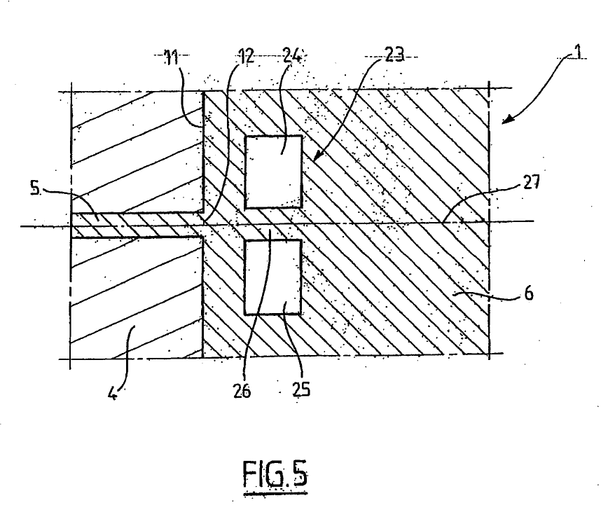

FIG. 5 shows an enlarged horizontal cross section of one part of the optical structure of FIG. 1;

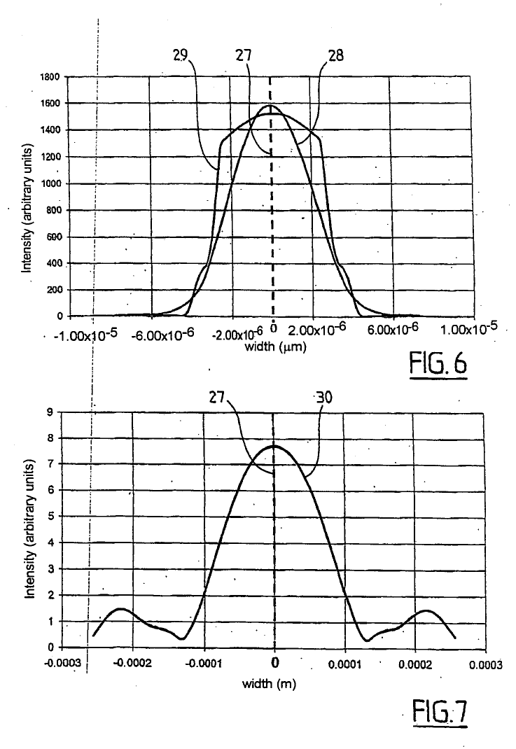

FIG. 6 shows a diagram of the intensity of the optical waves at two points in the aforementioned optical structure;

FIG. 7 shows a diagram of the intensities of the optical waves at another point in the aforementioned optical structure;

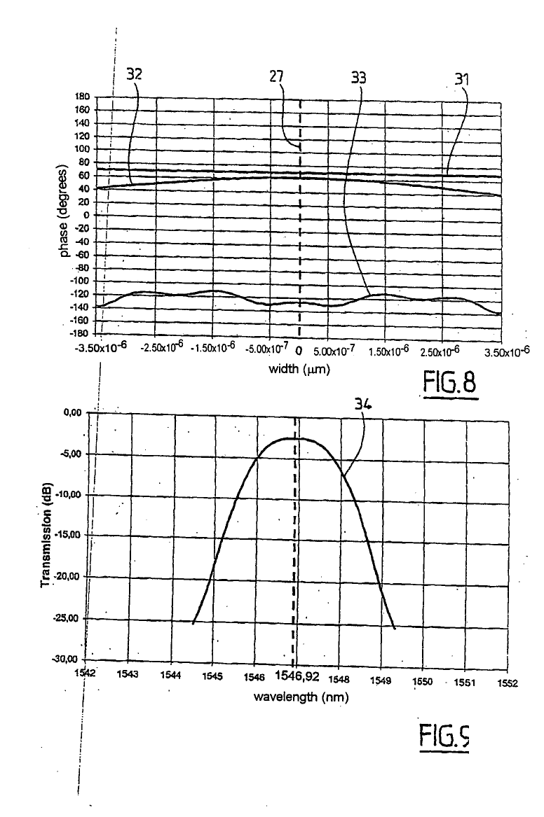

FIG. 8 shows a diagram of the phases of the optical waves at points in the aforementioned optical structure; and

FIG. 9 shows a diagram of the phases of the optical waves at points in the aforementioned optical structure.

The integrated optical structure 1, shown in FIGS. 1 to 5, comprises a base layer 2 on which have been deposited two layers 3 and 4 between which are embedded, so as to be coplanar and one after the other or in continuity, the core of an input optical microguide 5, an input optical coupling element 6, the cores of the intermediate optical microguides 7 of an intermediate network 8, an output optical coupling element 9 and the cores of output optical microguides 10.

The input optical coupling element 6 has an input face 11, to which the input microguide 5 is connected approximately perpendicularly, which input microguide 5 thus has an output end 12, and an output face 13 that is located facing the input face 11 and to which the intermediate microguides 7 are connected approximately perpendicularly, which intermediate microguides 7 thus have input ends 14.

The input optical coupling element 6 furthermore has lateral faces 15 and 16 that are remote from the region extending between the output 12 of the input microguide 5 and the inputs 14 of the intermediate microguides 7.

The output optical coupling element 9 has an input face 17 to which the intermediate microguides 7 are connected approximately perpendicularly, which intermediate micro-guides 7 thus have output ends 18, and an output face 19 that is located facing the input face 17 and to which the output microguides 10 are connected approximately perpendicularly, which output microguides 10 thus have input ends 20.

The output optical coupling element 9 furthermore has lateral faces 21 and 22 that are remote from the region extending between the outputs 18 of the intermediate microguides 7 and the inputs 20 of the output microguides 9.

The intermediate microguides 7 of the network 8 are formed beside one another and a certain distance apart, and are of different lengths, which increase from the waveguide placed in the middle to the waveguides placed at the outside.

The output microguides 10 are formed beside one another and a certain distance apart, and extend parallel to one another.

The optical microguides 5, 7 and 10 and the optical coupling elements 6 and 9 are made of a material whose refractive index is greater than the refractive index of the material or materials constituting the layers 3 and 4.

In an illustrative embodiment, the base layer 2 consists of a silicon substrate and the layers 3 and 4 are made of undoped silica. The optical microguides 5, 7 and 10 and the optical coupling elements 6 and 9 are made of doped silica, of silicon nitride or of silicon oxynitride.

In practice, the layer 3 is deposited on the support plate 2, a layer 5a is deposited and etched so as to produce the optical microguides 5, 7 and 10 and the optical coupling elements 6 and 9, and then the layer 4 is deposited.

By way of indication, the optical microguides 5, 7 and 10 are of rectangular or square cross section. The layer 5a has a thickness of about 5 microns and the thicknesses of the layers 3 and 4, above the aforementioned microguides and coupling elements, are about 12 microns. The distances laterally separating the inputs 14 of the intermediate microguides 7, the distances laterally separating the outputs 18 of the intermediate microguides 7 and the distances laterally separating the inputs 20 of the output microguides 9 are approximately equal to their widths.

It follows from the foregoing that an optical wave leaving via the output end 12 of the input microguide 5 is able to illuminate the input ends 14 of the inter-mediate microguides 7 of the network 8, through the input optical coupling element 6. This input optical coupling element 6 thus defines a region of free propagation of the light, confined in its thickness but not bounded laterally.

Likewise, the optical waves leaving via the output ends 18 of the intermediate microguides 7 are able to illuminate the input ends 20 of the output microguides 10, through the output optical coupling element 9. This output optical coupling element 9 thus defines a region of free propagation of the light, confined in its thickness but not bounded laterally.

Optical transfer or transformation means 23 are produced in the input optical coupling element 6, these means being placed at a point located a short distance from and transversely across the output end 12 of the input microguide 5.

These means 23 constitute obstacles at least partly opposing normal propagation of the light emanating from the output 12 of the input microguide 5 before said light reaches the inputs 14 of the intermediate microguides 7 of the network 8.

As shown more precisely in FIGS. 2 and 5, the obstacles 23 consist of two slots or elongate cavitied parts 24 and 25 produced in the thickness of the layers 3 and 4 and across the optical coupling element 6.

These slots 24 and 25 lie approximately in a plane perpendicular to the main light output direction of the input microguide 5 and between them define, facing the output end of the input microguide, a space 26 for passage of the light toward the inputs 14 of the intermediate microguides 7 of the network 8.

In general, it is desirable for the facing edges of the slots 24 and 25 that define the passage 26 to be tangents, on the outside, to the sides of an angle whose vertex is located at the center of the output end 12 of the input microguide 5 and the value of which is between 0.5 and 25 degrees.

Furthermore, the obstacles 23 are preferably placed on the object surface of the inputs 20 of the output optical waveguides 10 across the optical system consisting of that part of the input optical coupling element 6 that extends between the obstacles 23 and the inputs 14 of the intermediate microguides 7 of the network 8, the intermediate microguides 7 and the output optical coupling element 9.

In one illustrative embodiment, the distance separating the output 12 of the input microguide 5 from the means 23 consisting of the slots 24 and 25 is approximately equal to three times the width of this input microguide 5 and the width of the space bounded by the facing edges of the slots is approximately equal to the width of the input microguide 5.

Furthermore, the output face 13 of the input optical coupling element 6 is preferably placed on an arc of a circle centered on the middle of the passage 26 of the means 23 consisting of the slots 24 and 25.

The integrated optical structure 1 may be designed so as to operate in the following manner.

Let us assume that an input optical wave transporting or containing optical-signal channels C₁-Cₙ, which are arranged in such a way that the distance separating their successive nominal wavelengths is preferably equal to a set value and/or a multiple of this set value, propagates in the input microguide 5 toward its output end 12.

The lengths of the microguides are then, relative to one another, such that the difference in length between two adjacent microguides is equal to an integral number of the central wavelength measured in the microguides 7 of the network 8.

Beyond this end 12, the input optical wave diffracts in the input optical coupling element 6, toward the obstacle 23 consisting of the slots 24 and 25.

The diffracted optical wave passes through the passage 26 produced between the slots 23 and 24, but is stopped by these slots that are on either side of this passage 26.

The optical wave passing through the passage 26 diffracts toward the inputs 14 of the intermediate microguides 7 of the network 8. The obstacle 23 thus constitutes an auxiliary light source facing the inputs 14 of the intermediate microguides 7 of the network 8.

The means 23 consisting of the slots 24 and 25 transform the input wave in the following manner.

As shown in FIG. 6, the curve representing the spatial distribution of the intensity of the optical wave leaving the input microguide 5 and penetrating the optical coupling element 6 is, when plotted as a function of the lateral widthwise distance from the mid-axis 27 of the input microguide 5 and of the passage 26 that separates the slots 24 and 25, in the form of a Gaussian curve 28.

As shown in FIG. 6, after the obstacle 23, the curve showing the spatial distribution of the intensity of the optical wave leaving the slot 26 is, when plotted as a function of the lateral widthwise distance from the mid-axis 27, in the form of a bell with a flattened top or of a rectangle 29.

As shown in FIG. 7, the far field, that is to say its diffraction pattern 30, of rectangular shape, is a cardinal sine function. Consequently, the curve showing the intensity of the optical wave reaching the network 8 is, when plotted as a function of the lateral widthwise distance from the mid-axis 27, in the form of a cardinal sine.

FIG. 8 shows that the curve representing the phase of the optical wave changes as it passes through the passage 26 of the obstacle 23, resulting in the sudden attenuation of the sides of the spatial distribution of the optical wave output by the input microguide 5. In the example shown, in which the phase is plotted as a function of the lateral widthwise distance from the mid-axis 27, curve 31 representing the phase of the optical wave just as it exits the input microguide 5 is approximately constant, curve 32 representing the phase of the optical wave just before the passage 26 is arched and having a maximum, and curve 33 representing the phase of the optical wave just after the passage 26 is shifted and slightly undulated.

The inputs 14 of the intermediate microguides 7 of the network 8 take respective samples from the optical wave that reaches or illuminates them.

These optical wave samples propagate along the intermediate microguides 7 of the network 8 as far as their ends 18. In the case of the central wavelength, the fields in each intermediate microguide 7 will arrive at their output end 18 with an equal phase and the distribution of the intensity at the input end of the network 8 is reproduced at its output end.

Beyond the ends 18 of the network 8, the sample waves diffract in the output optical coupling element 9 and reach or illuminate the input ends 20 of the output microguides 10.

The input ends 20 of the output microguides 10 take up the optical wave that illuminates them.

The optical waves propagating in the respective output microguides 8 transport or contain the channels initially transported or contained in the input optical wave conveyed by the input microguide 5. This results from the fact that the dispersive appearance is manifested only on the surface 19, when the wavelength channels are separated owing to the linear increase in length of the microguides 7 of the network 8, causing a different phase for each of the wavelength channels transported. Consequently, the optical beam is shifted and focused at various points on the surface 19.

As FIG. 9 shows, as a consequence of the effects of the obstacle 23, curve 34, showing respectively the transmission ratios of the intensity of the optical waves propagating in the output microguides 10 and the incident intensity emanating from the input microguide 5, are, when plotted as a function of the deviation from the corresponding nominal wavelength, in the form of bells with flattened tops.

In one illustrative embodiment, the nominal values of the optical wavelengths defining the channels transported by the input microguide 5 could be in accordance with the ITU grid and are consequently separated by 1.6 nanometers. In this case, the obstacle 23 could be located at 19 microns from the output end 12 of the input microguide and the slots could be separated by 9.5 microns.

The present invention is not limited to the examples described above. Many alternative embodiments are possible without departing from the scope defined by the claims appended hereto.

In one alternative embodiment, the structure 1 could have several input optical microguides 5 emerging in the face 11 of the input coupling element 6. In such a case, obstacles having common slots between two adjacent microguides could be provided.

In another alternative embodiment, the means 23 could consist of slots 24 and 25 that are filled with a material whose refractive index would be different from that of the material constituting the input coupling element 6, such that some of the light emanating from the output end 12 of the input microguide could pass through them toward the inputs 14 of the intermediate microguides 7 of the network 8. In accordance with the abovementioned examples, this material filling the slots 24 and 25 could be silicon nitride, silicon oxynitride or silicon.

In another alternative embodiment, the means 23 could be produced by modifying the refractive index of the input optical coupling element of a region corresponding to the slots 24 and 25 in order to stop the optical wave or to attenuate its propagation. This modification could be obtained by doping the material.

Many other alternative embodiments are possible without departing from the scope defined by the claims appended hereto.

1. An integrated optical structure comprising at least one layer in which an optical coupling element (6) defining a free propagation region for the light, at least one input optical waveguide (5) and optical waveguides (7) constituting a network (8) are defined, these being arranged one with respect to another in such a way that the optical wave leaving via the output end of said input optical waveguide reaches the input ends of the optical waveguides constituting said network through said optical coupling element, characterized in that said optical coupling element (6) includes, in a place located at a certain distance from and transversely across the aforementioned output end of said input optical waveguide, optical transfer or transformation means (23) for attenuating the amplitude and/or modifying the phase and/or partly stopping the propagation of the optical wave emanating from the output of the input optical waveguide (5) before said wave reaches the aforementioned inputs of the optical waveguides (7) of said network (8).

2. An integrated wavelength-multiplexing/-demultiplexing structure of optical-signal channels arranged in such a way that the distance separating their successive nominal wavelengths is preferably equal to a set value and/or to a multiple of this set value, comprising, in at least one layer, at least one input optical waveguide, output optical waveguides, a network (8) of intermediate waveguides (7) having different lengths, an input optical coupling element (6) defining a free propagation region that extends between the output end of the input optical waveguide and the input ends of the optical waveguides of said network in such a way that the optical wave emanating from the input optical waveguide reaches the inputs of the intermediate optical waveguides of said network through said optical coupling element, and an output optical coupling element (9) defining a free propagation region that extends between the output ends of the intermediate optical waveguides of said network and the input ends of the output waveguides in such a way that the optical waves emanating from the outputs of the intermediate optical waveguides of said network reach the inputs of the output optical waveguides through said optical coupling element, characterized in that said input optical coupling element (6) includes, in a place located at a certain distance from and transversely across the aforementioned output end of said input optical waveguide, transfer or transformation means (23) for attenuating the amplitude and/or modifying the phase and/or partly stopping the propagation of the optical wave emanating from the input optical waveguide before said wave reaches the aforementioned inputs of the optical waveguides of said network, in such a way that the intensity of the optical waves reaching the respective inputs of the output optical waveguides is, when plotted as a function of the deviation from the corresponding nominal wavelength, in the form of a bell with a flattened top or of a rectangle.

3. The optical structure as claimed in claim 1, characterized in that said transfer or transformation means (23) comprise obstacles (24, 25) that at least partly prevent propagation of the light emanating from the output of the input optical guide and define, between said obstacles, a space (26) for passage of the light, preferably placed transversely, from the output of the input waveguide (5).

4. The optical structure as claimed in claim 1, characterized in that said obstacles (23) comprise cavitied parts or spaced-apart slots (24, 25).

5. The optical structure as claimed in claim 1, characterized in that the opening of the angle whose vertex is located on the output of said input waveguide, and the sides of this angle are tangents to said space (26) separating said parts of said transfer or transformation means, is between 0.5 and 25 degrees.

6. The optical structure as claimed in claim 1, characterized in that said transfer or transformation means (23) are placed on the image surface comprising the inputs of the output optical waveguides, through the optical system consisting of that part of the input optical coupling element (6) that extends between said transfer or transformation means and the inputs of the optical waveguides (7) constituting said network (8) and the output optical coupling element (9).

7. An integrated optical structure comprising at least one layer in which an optical coupling element (6) defining a free propagation region for the light, at least one input optical waveguide (5) and optical waveguides (7) constituting a network (8) are defined, these being placed one with respect to another in such a way that the optical wave leaving via the end of said input optical waveguide reaches the input ends of the optical waveguides constituting said network through said optical coupling element, characterized in that said optical coupling element (6) comprises, in a place located at a certain distance from and transversely across the aforementioned output end of said input optical waveguide, obstacles (24, 25) at least partly preventing propagation of the light emanating from the output of the input optical waveguide before said light reaches the aforementioned inputs of the optical waveguides of said network and defining, between them, a space for passage of the light to the aforementioned inputs of the optical waveguides of said network.

8. The optical structure as claimed in claim 7, characterized in that said obstacles (23) consist of elongate slots (24, 25) formed approximately in a plane perpendicular to the main direction of the output of the light from the input waveguides.

9. The optical structure as claimed in claim 8, characterized in that the slots (24, 25) extend over at least the thickness of the waveguides (5, 6).

10. The optical structure as claimed in claim 7 characterized in that said obstacles (23) are placed on the image surface comprising the inputs of the output optical waveguides, through the optical system consisting of that part of the optical coupling element that extends between said transfer or transformation means and the inputs of the optical waveguides constituting said network and the output optical coupling element.

11. A process for producing the optical structure as claimed in claim 7, characterized in that it consists in embedding the transmission cores of said optical waveguides in a layer (3, 4), and in producing said obstacles in the thickness of this layer.

12. The optical structure as claimed in claim 2, characterized in that said transfer or transformation means (23) comprise obstacles (24, 25) that at least partly prevent propagation of the light emanating from the output of the input optical guide and define, between said obstacles, a space (26) for passage of the light, preferably placed transversely, from the output of the input waveguide (5).

13. The optical structure as claimed in claim 2, characterized in that said obstacles (23) comprise cavitied parts or spaced-apart slots (24, 25).

14. The optical structure as claimed in claim 2, characterized in that the opening of the angle whose vertex is located on the output of said input waveguide, and the sides of this angle are tangents to said space (26) separating said parts of said transfer or transformation means, is between 0.5 and 25 degrees.

15. The optical structure as claimed in claim 2, characterized in that said transfer or transformation means (23) are placed on the image surface comprising the inputs of the output optical waveguides, through the optical system consisting of that part of the input optical coupling element (6) that extends between said transfer or transformation means and the inputs of the optical waveguides (7) constituting said network (8) and the output optical coupling element (9).

16. The optical structure as claimed in claim 8 characterized in that said obstacles (23) are placed on the image surface comprising the inputs of the output optical waveguides, through the optical system consisting of that part of the optical coupling element that extends between said transfer or transformation means and the inputs of the optical waveguides constituting said network and the output optical coupling element.

17. The optical structure as claimed in claim 9 characterized in that said obstacles (23) are placed on the image surface comprising the inputs of the output optical waveguides, through the optical system consisting of that part of the optical coupling element that extends between said transfer or transformation means and the inputs of the optical waveguides constituting said network and the output optical coupling element.

18. A process for producing the optical structure as claimed in claim 8, characterized in that it consists in embedding the transmission cores of said optical waveguides in a layer (3, 4), and in producing said obstacles in the thickness of this layer.

19. A process for producing the optical structure as claimed in claim 9, characterized in that it consists in embedding the transmission cores of said optical waveguides in a layer (3, 4), and in producing said obstacles in the thickness of this layer.

20. A process for producing the optical structure as claimed in claim 10, characterized in that it consists in embedding the transmission cores of said optical waveguides in a layer (3, 4), and in producing said obstacles in the thickness of this layer.
